(19) United States
(12) Patent Application Publication
(10) Pub. No.: US 2015/0308807 A1
(43) Pub. Date: Oct. 29, 2015

(54) Count on it - Digital Tape Measure Counter

(71) Applicant: Nathaniel Rhoden, Granger, IN (US)

(72) Inventor: Nathaniel Rhoden, Granger, IN (US)

(21) Appl. No.: 14/120,085

(22) Filed: Apr. 25, 2014

(51) Int. Cl. G01B 3/10

(52) U.S. Cl. CPC G01B 3/1061; G01B 2003/1069

(57) ABSTRACT

The Count on it—digital tape measure counter is a digital tape measure with one display in three parts that incorporates a count feature. You will measure one piece then save that size. Then take the full measurement and the count number will display. It has many uses and is perfect for inventory control.

There is no federally sponsored or research or development associated with this application. There is no joint research agreement associated with this application.

### BACKGROUND OF THE INVENTION

(1) Field of the Invention

There are many tape measure and many digital tape measures that measure a distance and display it. The Count on it—digital tape measure counter is unique that it can count objects by a measurement.

(2) Description of the art including information disclosed under 37 CFR 1.97 & 1.98

The art described in the drawings of the design and utility function illustrate the unique ability of the invention and we have found no other patents that would pose a problem with this application as we could find.

### BRIEF SUMMARY OF THE INVENTION

This is a digital tape measure with a digital display that will allow you to lock in a measurement, then use that measurement to count various products. This feature will be used in many inventory control, auditing, tile or flooring layouts or various home or production uses. This will be the only tape measure that can be used as a counting device.

### BRIEF DESCRIPTION OF THE SEVERAL VIEWS OF THE DRAWINGS

There are 8 drawings in total that describe and illustrate the design and function of the Count on it—digital tape measure counter.

FIG. 1: is the left ¾ view top, front, side perspective of the invention.

FIG. 2: is the left side view.

FIG. 3: is the top view.

FIG. 4: is the bottom view.

FIG. 5: is the front view.

FIG. 6: is the back view.

FIG. 7: is the right ¾ view top, front, side perspective of the invention.

FIG. 8: is the exploded view of the interior of the invention.

### DETAILED DESCRIPTION OF THE PREFERRED EMBODIMENT

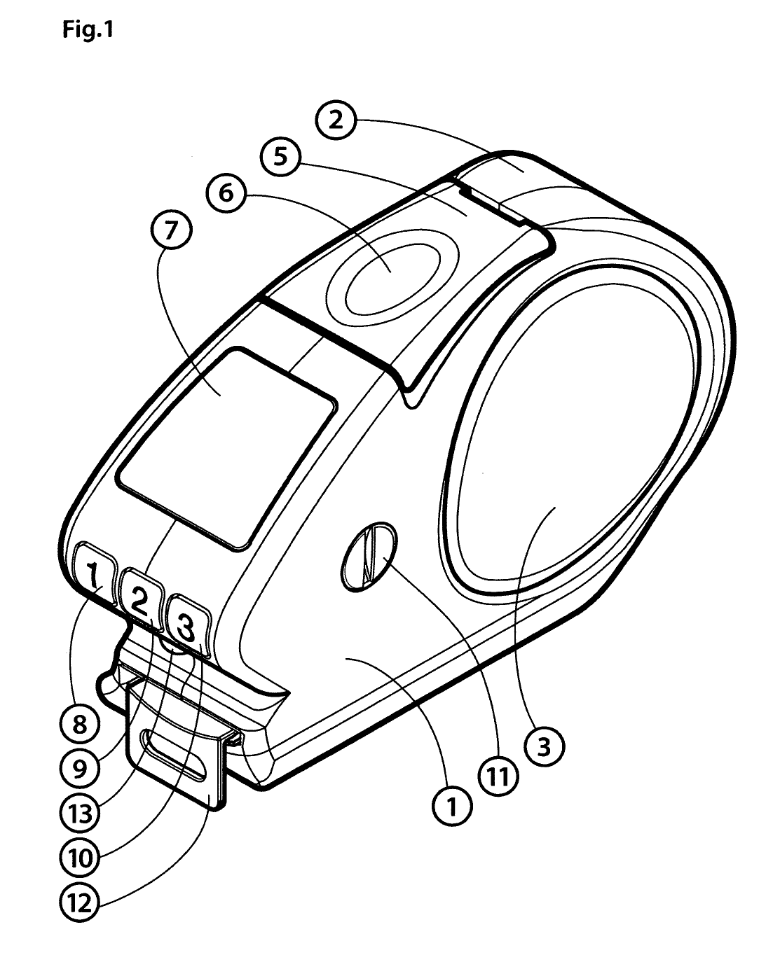

FIG. 1: In this ¾ top left side and front view illustration #1 is the body shell left side with #2 the body shell right side with #3 the left side grip area with #5 the tape retraction release button with #6 the finger depression with #7 the LCD display with # 8 the capacitive touch button number one with #9 the capacitive touch button number two with #10 the capacitive touch button number three with #11 the battery access cover with #12 the tape measure end clip with #13 the tape illumination LED light.

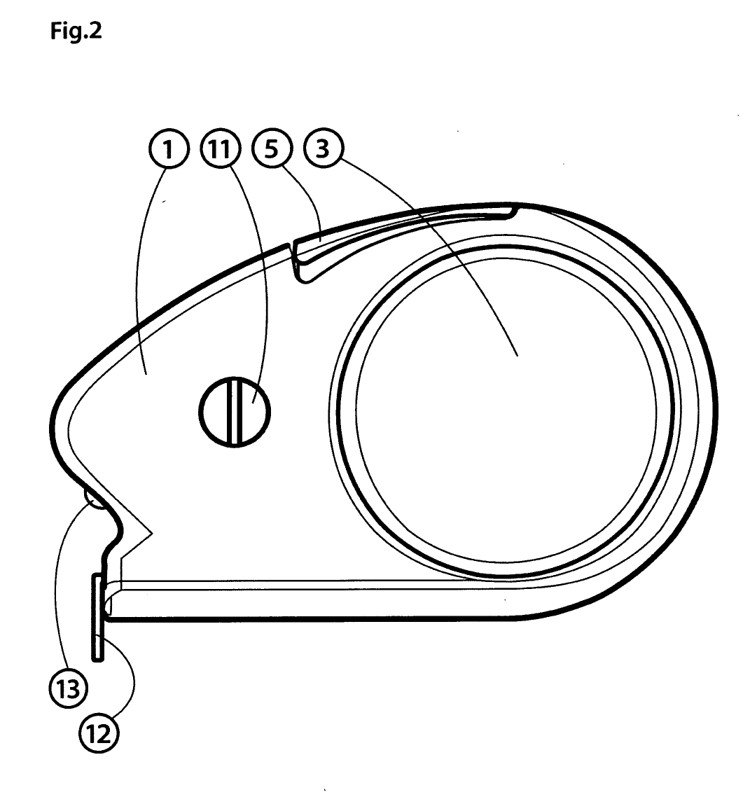

FIG. 2: In this left side view illustration #1 is the body shell left side with #3 the left side grip area with #5 the tape retraction release button with #11 the battery access cover with #12 the tape measure end clip with #13 the tape illumination LED light.

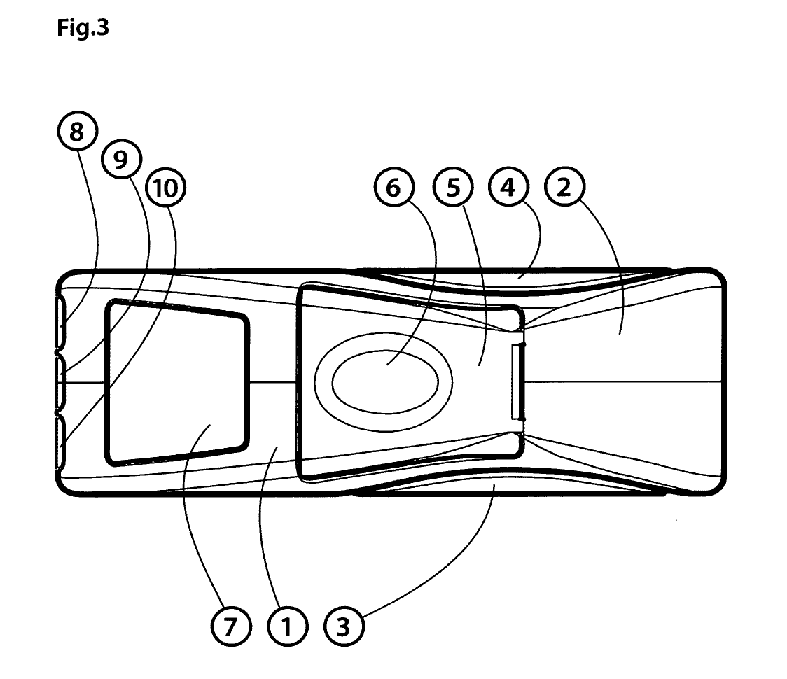

FIG. 3: In this top view illustration #1 is the body shell left side with #2 the body shell right side with #3 the left side grip area with #4 the right side grip area with #5 the tape retraction release button with #6 the finger depression with #7 the LCD display with # 8 the capacitive touch button number one with #9 the capacitive touch button number two with #10 the capacitive touch button number three.

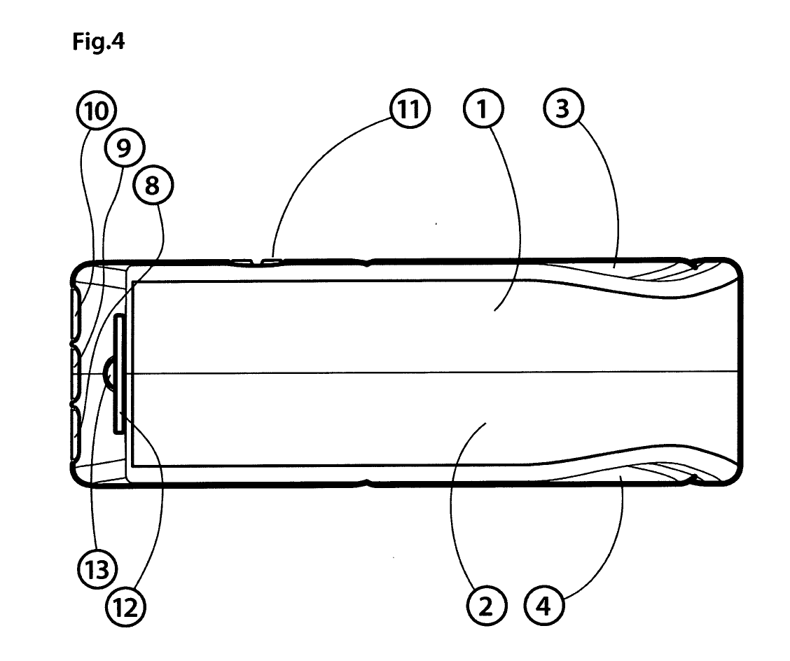

FIG. 4: In this bottom view illustration #1 is the body shell left side with #2 the body shell right side with #3 the left side grip area with #4 the right side grip area with # 8 the capacitive touch button number one with #9 the capacitive touch button number two with #10 the capacitive touch button number three with #11 the battery access cover with #12 the tape measure end clip with #13 the tape illumination LED light.

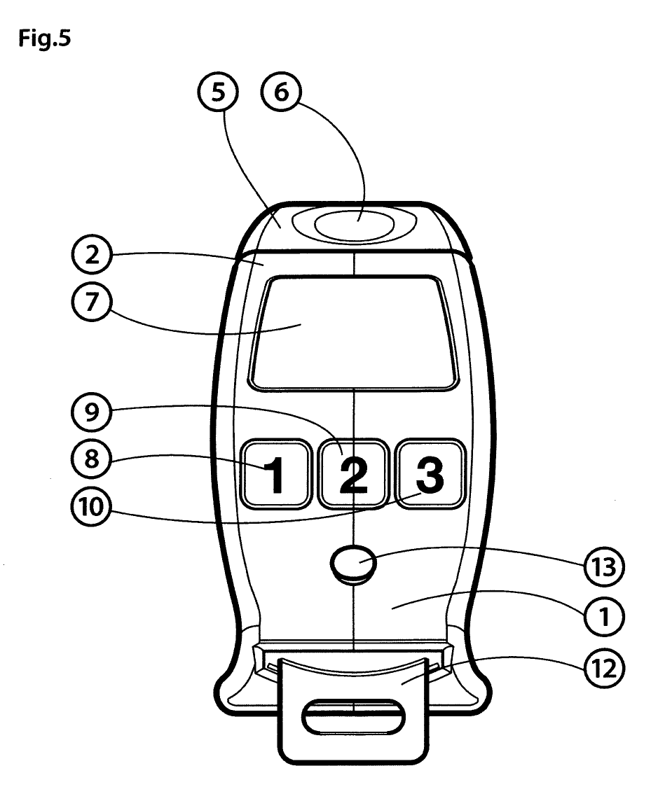

FIG. 5: In this front view illustration #1 is the body shell left side with #2 the body shell right side with #5 the tape retraction release button with #6 the finger depression with #7 the LCD display with # 8 the capacitive touch button number one with #9 the capacitive touch button number two with #10 the capacitive touch button number three with #12 the tape measure end clip with #13 the tape illumination LED light.

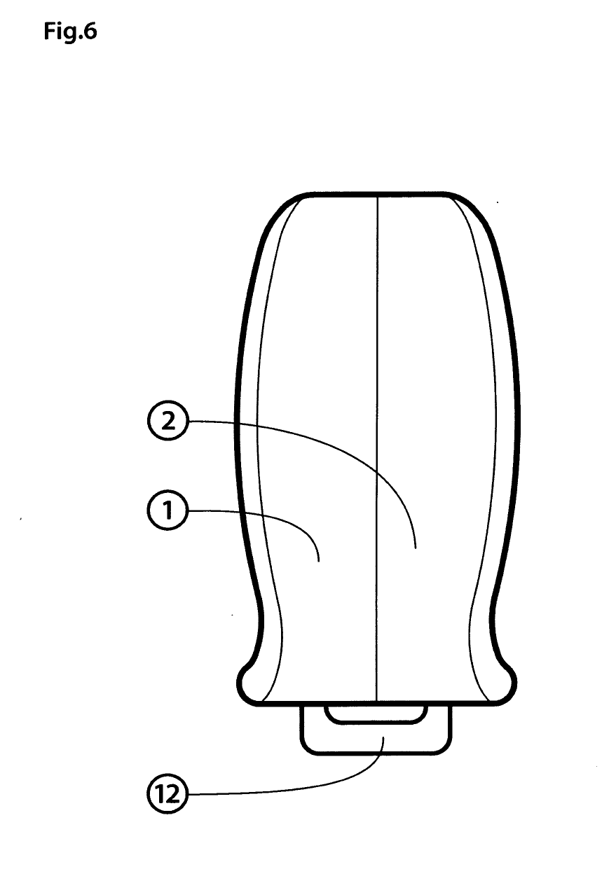

FIG. 6: In this back side view illustration #1 is the body shell left side with #2 the body shell right side with #12 the tape measure end clip.

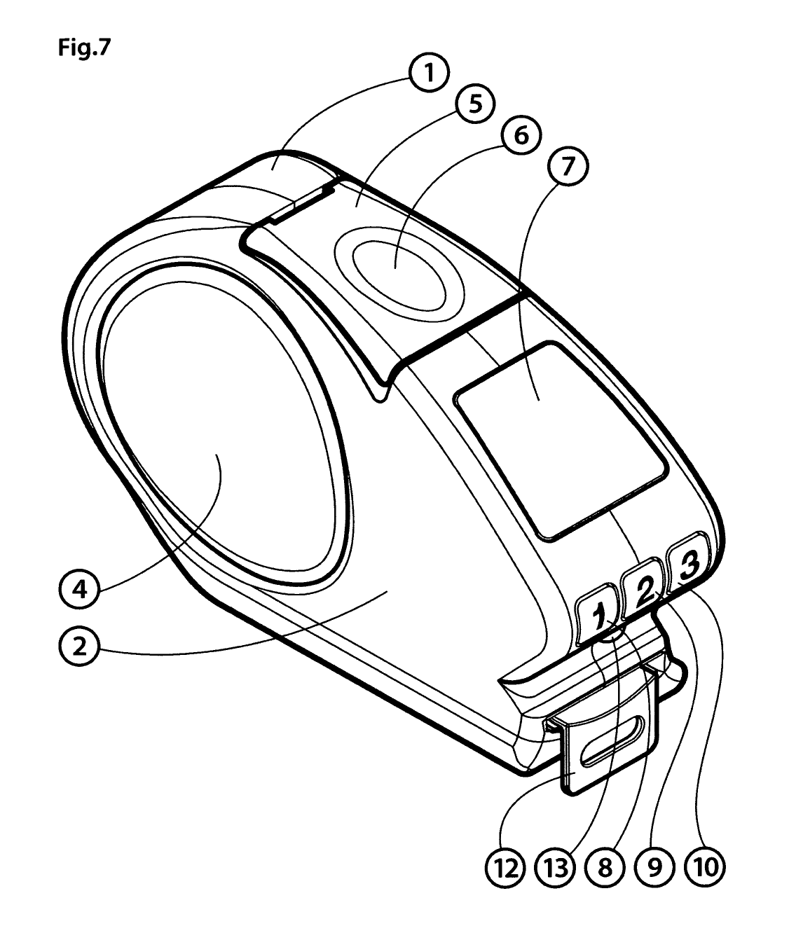

FIG. 7: In this ¾ top, front, right side view illustration #1 is the body shell left side with #2 the body shell right side with #4 the right side grip area with #5 the tape retraction release button with #6 the finger depression with #7 the LCD display with # 8 the capacitive touch button number one with #9 the capacitive touch button number two with #10 the capacitive touch button number three with #12 the tape measure end clip with #13 the tape illumination LED light.

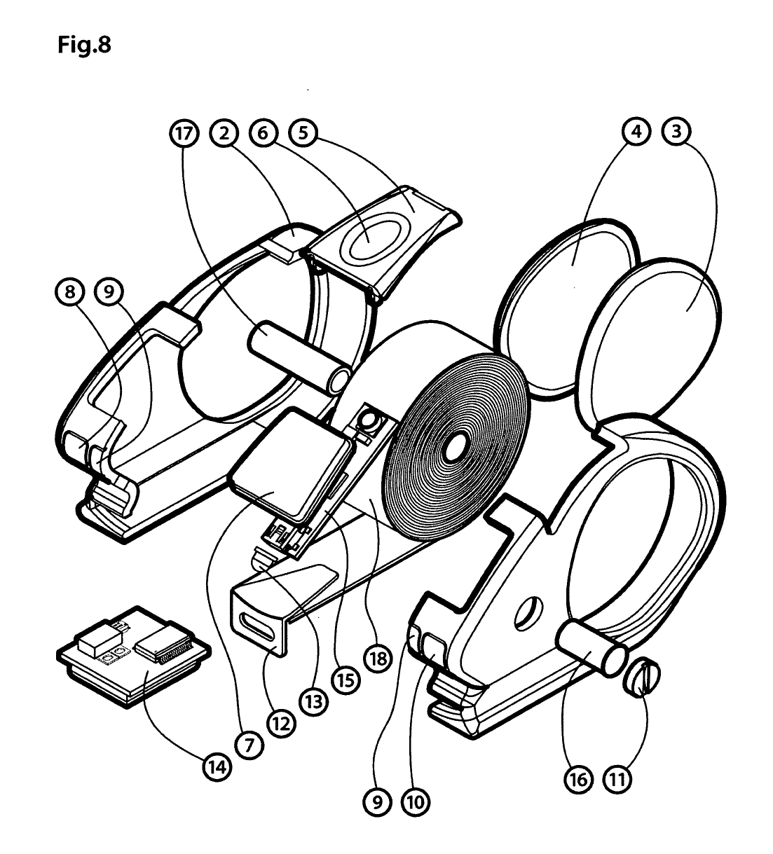

FIG. 8: In this exploded view showing the interior of the invention illustration #1 is the body shell left side with #2 the body shell right side with #3 the left side grip area with #4 the right side grip area with #5 the tape retraction release button with #6 the finger depression with #7 the LCD display with # 8 the capacitive touch button number one with #9 the capacitive touch button number two with #10 the capacitive touch button number three with #11 the battery access cover with #12 the tape measure end clip with #13 the tape illumination LED light with #14 the measuring sensor with #15 the display and button logic IC board with #16 the battery with #17 the tape spindle with #18 the metallic coil winding tape measure.

### DETAILED DESCRIPTION OF THE INVENTION

This is a digital tape measure with a digital display that will allow you to lock in a measurement, then use that measurement to count various products. This feature will be used in many inventory control systems, auditing, tile or flooring layouts or various home or production uses. This will be the only tape measure that can be used as a counting device.

Features: There are three buttons.

### Button #1=Save

If digital tape measure reads greater than “0”, by depressing Button #1 it will remember the measurement length, it will also display on the LCD screen.

If continued use, by continuing to depress Button #1 it will continue to remember up to 8 different sizes, only the last measurement saved will show on the LCD.

If the tape reads “0” by depressing Button #1 it will display up to 8 of the last saved measurements in a Last to First order.

RESET SAVE—If the tape reads “0” by depressing Button #1 and holding for 3 second will clear all saved measurements.

### Button #2=Inch/Inch Fractions/Millimeter

This button will give you measurement choices between the Inches with decimals, Inches with fractions, and millimeters. Upon using the Tape Measure the first time the default will be in INCH the digital tape measure will read out for example 4.75 In, it will remember to last preference thereafter.

By depressing Button #2 once, it will go to the next readout selection in rotations of Inch/Inch Fractions/Millimeter, the Inch Fraction readout example would be 4¾ Inch.

By depressing Button #2 again, it will go to next readout option in Millimeters the read out for example would be 120.65 mm.

### Button #2=Continued

At any time, if a measurement was saved in any measurement readout option, by depressing Button #2 would convert to Inch/Inch Fractions/Millimeter.

This means if I measure and save 4.75 In with the Inch format, by depressing Button #2 once it will display 4¾ In converting it to the Inch Fractions format, by depressing Button #2 again it will convert to Millimeter displaying 120.65 mm.

From the Millimeter display if depressing Button #2 it will wrap back to the Inch format.

### Button #3=Count-On-It

This button will remember a size that will be used for the counting feature; programming will allow this size to automatically be divided by total size giving the count.

If Button #2 has been set to Inch format, by measuring an item that is 0.75 and depressing Button #3 the size then will be used to count. Every time the tape travels 0.75 will=1 Count. If measuring several of 0.75 inch pieces totaling 19.5 inches, you will get a 26 Count. Meaning there are 26 pcs of 0.75 inch items in the stack.

RESET SAVE—If the tape reads “0” by depressing Button #1 and holding for 3 second will clear all saved measurements.

### Combination Buttons #1 & #3=“0”Feature

By allowing the tape to auto retract depressing both button 1 & 3 will result in a “0” amount allowing the user to recalibrate the tape measure to ensure accuracy. By first making sure the tape measure it close and depressing both #1 Button & #3 Button simultaneously for 3 seconds it will reset the tape measures readout to read “0” to ensure accuracy.

### How to Use:

The Digital Tape measure will have a working standard tape measure that can be used in conjunction with the digital displays and programming.

Step 1: Using Button #2, choose the measurement display options you prefer the digital tape measure to display Inch/Inch Fractions/Millimeter (see above)

Step 2: Measure one item or by hand pull tape to the desired measurement needed to count by. Depress Button #3 to save the desired count size. This size will display on the LCD screen.

Step 3: Measure the total pieces or length, the count by measurement we saved will divide into the total and be displayed on the LCD display.

### Example 1

(1) Measure 1 pieces, lock size in by depressing Button #3—This will now count by this size.
(2) Measure Bundle, now that the size of 1 piece is locked in, when you measure the bundle, the pieces count within the Bundle will appear.
(3) This works by computing: TOTAL (Size)/Pieces(Sized)=COUNT
For the above example once you have the pieces size locked in, you can audit or count several bundles as long as the individual pieces are the same size.

### Example 2

1) Measure 1 Tile length, lock size in by depressing Button #3 and this will now count by this size.
2) Measure Room, now that the size of 1 piece is locked in, when you measure the room the pieces of tile needed for the length of the room will appear.
3) This works by computing: TOTAL (Size)/PCS (Sized)=COUNT

For the above example once you have the piece size locked in, you can figure the amount of tiles needed quickly, repeat for the width and times the two numbers and you just figured quickly how many tiles to buy. You can even add the grout line in before locking to the count by number feature (Button #3) to ensure greater accuracy.

### Example 3

1) Measure 1 board width, lock size in by depressing Button #3 and this will now count by this size.
2) Measure desired deck width, now that the size of 1 piece is locked in, when you measure the width of the deck, the total pieces of decking needed will appear.
3) This works by computing: TOTAL (Size)/PCS (Sized)=COUNT

For the above example once you have the piece size locked in, you can figure the amount of deck boards needed quickly, repeat for the width and times the two numbers and you just figured quickly how many deck boards to buy. You can even add the deck spacing desired before locking to the count by (Button #3) to ensure greater accuracy.

### Count-On-It Uses:

This product has three main uses.
1) Can be used as a standard tape measure.
2) An easy inch to millimeter or millimeter to inch conversions. (See Button #2)
3) Will help count multiple items using a given measurement. (See Button #3)

What is claimed is:

1. A digital tape measure counter main body comprising of:
a two piece main body with a left and right side grip area that is contoured for a person's hand structure for a left handed person or right handed person;
a three part LCD screen in the front portion of the main body that displays an initial measurement in the top portion of the LCD screen and a second measurement displays in inches or decimals or millimeters in the center portion of the LCD screen and a third pieces count displays in the bottom portion of the LCD screen;
a tape illumination LED light with a battery and battery access cover for easy replacement.

2. A display and button logic IC board comprising of:
a digital tape measure sensor that reads greater than “0” and by depressing the capacitive button number one will save that measurement length and display it on the LCD screen and will save up to 8 separate measurements from the last to first order;
a capacitive button number two that will give measurement choices in inches with decimals, inches with fractions, and millimeters if a measurement with no count feature is desired or if the user needs a specific type of measurement;
a capacitive button number three will compute the initial measurement from button number one and divide the total measurement and display the count number.

3. Three capacitive buttons with detailed functionalities comprising of:
a button #1 that has a reset save feature that by depressing button #1 and holding it for three seconds it will clear all saved measurements;
a button #2 that will convert measurement types from one to another while the measurement is being made;
a button #2 that when depressed and taking a measurement of 4.75 inches could be converted to 4 ¾ inches or converted to 120.65 mm (millimeters) when depressed each time;
a button #3 that will remember an initial measurement size that is used for the counting feature and is programmed to allow this size to be divided by the total size giving an exact count of the number pieces being measured to the total measurement and can be counted by using any type of measurement in inches and decimals or inches and fractions and in millimeters.
